(19) United States
(12) Patent Application Publication
(10) Pub. No.: US 2022/0148051 A1
(43) Pub. Date: May 12, 2022

(54) MACHINE LEARNING BASED METHOD OF RECOGNISING FLOORING TYPE AND PROVIDING A COST ESTIMATE FOR FLOORING REPLACEMENT

(71) Applicant: INDEPENDENT FLOORING VALIDATION LTD, Middlesex (GB)

(72) Inventors: David BAGNALL, Middlesex (GB); Kesar BREEN, Middlesex (GB)

(21) Appl. No.: 17/429,485

(22) PCT Filed: Feb. 10, 2020
(86) PCT No.: PCT/GB2020/050295

§ 371 Date: Aug. 9, 2021

(30) Foreign Application Priority Data
Feb. 8, 2019 (GB) 1901778.9

(51) Int. Cl. G06Q 30/02; G06N 3/04

(52) U.S. Cl. CPC G06Q 30/0283; G06N 3/0454

(57) ABSTRACT

There is provided a machine learning based method of providing a cost estimate for a floor repair or replacement service. The method includes the steps of receiving an image of a portion of a floor to be repaired or replaced from an end-user's application or web browser or web app running on the end-user's device; configuring one or more processors to generate, based on the received image, a cost estimate for the floor repair or replacement service using a machine learning model; and providing the cost estimate to the end-user's application or web browser or web app.

### BACKGROUND OF THE INVENTION

### 1. Field of the Invention

The field of the invention relates to machine learning based methods of recognising flooring type and providing a cost estimate for flooring replacement, and to related servers, systems and applications.

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### 2. Description of the Prior Art

When homeowners raise insurance claims over damaged carpets or other items, insurance companies historically send experts to the house to measure the damaged rooms, and to identify the type and value of the carpets to create a replacement valuation. In recent times some companies have incorporated a user taking a photograph of the carpet, flooring or other product, and then sending that back to the service provider to perform a human assessment of the image and transmit the information back to the user. Alternatively, the service provider can also ask the user to take a sample of the carpet, flooring or other product, so that they can complement the human assessment with the material analysis for better accuracy.

The number of people involved in an insurance claim can therefore sometimes be up to 6 people and it may also take up to 60 days from the customer notifying their insurer to receiving a payment.

The difficulty of this is evident: carpets come in a variety in types of material (synthetic, wool, wool mix, sisal etc), construction (Twist, Loop Berber, Saxony, Cut Loop, etc.), colour, patterns and weight (Extra Heavy, Heavy, Medium, Light, Extra Light). The difference within one category may be significant, while the difference between certain categories may be subtle.

Even though carpets may often look similar, prices may vary greatly for the insurance company as well as for the insurance policy holder. This is also true for other type of flooring or furniture for example.

There is still a need for an insurance claim based service that will automatically provide a rapid and accurate cost evaluation for repair or replacement of a physical item with minimum human involvement.

The present invention addresses the above vulnerabilities and also other problems not described above.

### SUMMARY OF THE INVENTION

There is provided machine learning based method of providing a cost estimate for a floor repair or replacement service, the method including the steps of: receiving an image of a portion of a floor to be repaired or replaced from an end-user's application or web browser or web app running on the end-user's device; configuring one or more processors to generate, based on the received image, a cost estimate for the floor repair or replacement service using a machine learning model; and providing the cost estimate to the end-user's application or web browser or web app.

Optional features in an implementation of the invention include any one or more of the following:
receiving the image is performed at a server.
The method includes a classifier machine learning approach which classifies the floor according to pre-defined categories.
a classifier predicts the likelihood that the received image is an image of the floor belonging to one or more pre-defined categories.
a classifier outputs the top most likely categories and provides the list of most likely categories to the end-user's application or web-browser or web app.
categories include one or more of: material type, construction type, colour, pattern, weight, thickness or manufacturer.
multiple cropped images are extracted from the received image and inputted to a first neural network, such as a deep convolutional network.
the first neural network outputs a feature vector from each inputted cropped image.
feature vectors are inputted into a second neural network, such as a fully connected deep neural network which outputs a score corresponding to the likelihood that a cropped image is an image of a floor that belongs to the one or more pre-defined categories.
scores for each cropped image are averaged.
a computer vision algorithm determines the probabilities that the received image belongs to the top most likely categories.
outputs from the classifier machine learning approach and the computer vision algorithm are combined in order to generate the list of most likely categories.
the method includes the step of training the machine learning model using a dataset of pre-labelled floor images in order to configure the machine learning model to predict the likelihood of the image to belong to pre-defined categories.
classifiers are trained by training multiple models with specific subset of a training dataset including pre-labelled floor images and comparing the predictive accuracy of the different training models.
the method includes the step of displaying to the end-user the top most likely categories and their corresponding cost estimate, such as the top 2 categories.
the end-user confirms or selects via the application or web browser or web app a category out of the top most likely categories displayed.
the end-user inputs via the application or web browser or web app the dimensions or shape of the flooring area that needs to be repaired or replaced.
a measuring algorithm determines the square meter needed for the floor repair or replacement service.
the image is captured at a fixed predetermined distance relative to the floor.
the image is captured with the flash on.
the end-user's device automatically determines the distance at which the image was captured.
the cost estimate is provided to the end-user's application or web-browser instantly or near-instantly such as in less than 4 seconds.
the method further includes the step of providing the cost estimate to a service provider's device.
the end user's device is a mobile device such as a smartphone, tablet, laptop computer or any other mobile device or web-connected equipment.
the end-user is able to request a cost estimate for further services or accessories in addition to the floor repair or replacement service, such as fitting, sub-floor preparation, underlay, metal bars, gripper, tape, glue, stair rod or any other services or accessories.
one or more processors are located at a remote server.
one or more processors are located in the end-user's device.
the end-user is able, via the application, to communicate directly with a service provider.
the end-user is able, via the application, to make a money payment to a service provider.
the method includes the step of providing a voucher or mandate or any other fulfilment process corresponding to the requested service to the end-user's application or web browser or web app.
the floor is any type of flooring such as carpet, brick, rugs, tile, stone or laminate.
the floor is a carpet and the measuring algorithm automatically estimates the number of rolls of carpet needed based on the roll's width and the dimensions or shape of the flooring area that needs to be repaired or replaced.
the carpet is classified by material type such as synthetic, wool, wool mix or sisal.
the carpet is classified by construction such as twist, loop berber, saxony, cut loop.
the carpet is classified by patterns.
the carpet is classified by weight such as lightweight, medium weight or heavy weight.
the classifier automatically determines or predicts the carpet's thickness.
the method is performed without requiring an expert assessment.
the method is performed without requiring a physical analysis of a floor sample.
the cost estimate is used to calculate a home insurance product for the end-user.

Another aspect is a machine learning based system for providing a cost estimate for a floor repair or replacement service, the system comprising one or more processors configured to: receive an image of a portion of the floor to be repaired or replaced from an end-user's application or web browser or web app running on the end-user's device; generate based on the received image a cost estimate for the floor repair or replacement service using a machine learning model; and provide the cost estimate to the end-user's application or web browser or web app.

Another aspect is a server configured to provide a cost estimate for a floor repair or replacement service, the server arranged to: receive an image of a portion of the floor to be repaired or replaced from an end-user's application or web browser or web app running on the end-user's device; generate a cost estimate for the repair or replacement of the floor using a machine learning model; and provide the cost estimate to the end-user's application or web browser or web app.

Another aspect is an application providing an end-user with an interface module configured to provide a cost estimate for a floor repair or replacement service, in which the end-user inputs an image of a portion of a floor to be repaired or replaced into the interface module and in which one or more processors, coupled to the interface module, are configured to generate, based on the received image, a cost estimate for the floor repair or replacement service using a machine learning model.

Another aspect is a machine learning based method of matching an end-user requesting a service to a list of service providers, the method comprising the steps of: receiving by a computer device a service request for floor repair or replacement from an end-user, such as a policy holder, the service request including an image of the floor to be repaired or replaced; configuring one or more processors to generate, based on the service request, a cost estimate for the floor repair or replacement service using a machine learning model; and matching the end-user to a list of service providers based on the service requested, and providing the list of service providers to the end-user.

Another aspect is a machine learning based method for recognising flooring type based on an image, comprising the steps of receiving an image of a floor and configuring one or more processors to predict the floor type or attribute using a classifier machine learning approach.

Another aspect is an application providing an end-user with an interface module configured to recognise flooring type or attribute based on an image, in which the end-user inputs an image of a portion of a floor into the interface module and in which one or more processors, coupled to the interface module, are configured to predict the floor type or attribute using a classifier machine learning approach, and in which the interface module is configured to display the predicted floor type or attribute to the end-user.

### BRIEF DESCRIPTION OF THE FIGURES

Aspects of the invention will now be described, by way of example(s), with reference to the following Figures, which each show features of the invention:

FIG. 1 shows a series of pictures of different carpets and their corresponding material type and price.

FIG. 2 shows a diagram illustrating the embedded process for flooring prediction.

FIG. 3 shows a diagram illustrating carpet categories.

FIG. 4 shows a diagram illustrating Flora metric training.

FIG. 5 shows a screenshot of the web-application.

FIG. 6 shows a screenshot of the web-application.

FIG. 7 shows a screenshot of the web-application.

FIG. 8 shows a screenshot of the web-application.

FIG. 9 shows a screenshot of the web-application.

FIG. 10 shows a screenshot of the web-application.

FIG. 11 shows a screenshot of the web-application.

FIG. 12 shows a screenshot of the web-application.

FIG. 13 shows a screenshot of the web-application.

FIG. 14 shows a screenshot of the web-application.

FIG. 15 shows a screenshot of the web-application.

FIG. 16 shows a screenshot of the web-application.

FIG. 17 shows a screenshot of the web-application.

FIG. 18 shows a screenshot of the web-application.

FIG. 19 shows a screenshot of the web-application.

FIG. 20 shows a screenshot of the web-application.

FIG. 21 shows a screenshot of the web-application.

FIG. 22 shows a screenshot of the web-application.

FIG. 23 shows a screenshot of the web-application.

FIG. 24 shows a screenshot of the web-application.

FIG. 25 shows a screenshot of the web-application.

FIG. 26 shows a screenshot of the web-application.

FIG. 27 shows a screenshot of the web-application.

FIG. 28 shows a screenshot of the web-application.

FIG. 29 shows a screenshot of the web-application.

FIG. 30 shows a screenshot of the web-application.

FIG. 31 shows a screenshot of the web-application.

FIG. 32 shows a screenshot of the web-application.

### DETAILED DESCRIPTION

An implementation of the invention relates to a machine learning based system for floor type recognition and classification in order to provide an accurate price estimate of floor replacement, in particular for handling an insurance policy claim or price comparison of floor products (e.g. in a retail environment). By ‘floor’ and ‘flooring’ we refer principally to floor coverings, such as carpets, vinyl, laminate, rugs, tiles, stone, as well as floor boards, as opposed to the underlying structural floor itself.

An implementation of the invention provides an automated way for an end-user, such as a policy holder, to obtain an instant and accurate flooring recognition and valuation without requiring an input from expert knowledge.

Additionally, the system may connect all relevant parties involved in an insurance claim handling into one central solution, from the policy holder, claim handler, insurer to retailers and estimators.

The system uses Metric learning, Deep convolutional neural network (DCNN) and computer vision image recognition to determine flooring type and value by photographing a portion of the flooring area with an image capturing device. This is combined with a measuring algorithm which, given room measurements either inputted by an end-user or automatically calculated, determines the square meter needed for flooring replacement. The information gathered provides an accurate valuation for the replacement of flooring. The replacement of flooring can then be done either through the production of an electronic voucher, mandate, cash settlement or direct fulfilment for example.

Key advantages of the system include, but are not limited to:
An overall quicker and simpler service compared to conventional methods, therefore saving money and time and reducing carbon footprint.
The number of people involved in a claim is down to only one end-user.
The number of days required from the customer notifying their insurer to receiving payment is considerably reduced, such as instantly or near instantly.
The platform provides a service that is cheaper than a traditional loss adjusting model, such as at least 30% cheaper.
The number of calls from dissatisfied customers is significantly reduced.
There is no longer the need to chase suppliers and a higher level of service to customers is provided.
By providing one central solution that the different stakeholders interacting with an insurance claim can use, a standardised practice can be achieved.

We now describe an implementation of the invention in which a machine learning based system is used to recognise and classify carpet type in order to provide an accurate cost estimate for carpet replacement. Using a measuring algorithm, the system calculates the square meter needed, factors the roll width, and creates an accurate and unbiased replacement cost estimate.

Whilst this description focuses on providing a cost estimate for carpet replacement, the methods and systems described can be applied more generally to any other insurance related services. This includes providing a cost estimate for repairing or replacing any physical structure within a home or building environment such as any type of flooring (i.e brick, laminate) or ceiling as well as furniture.

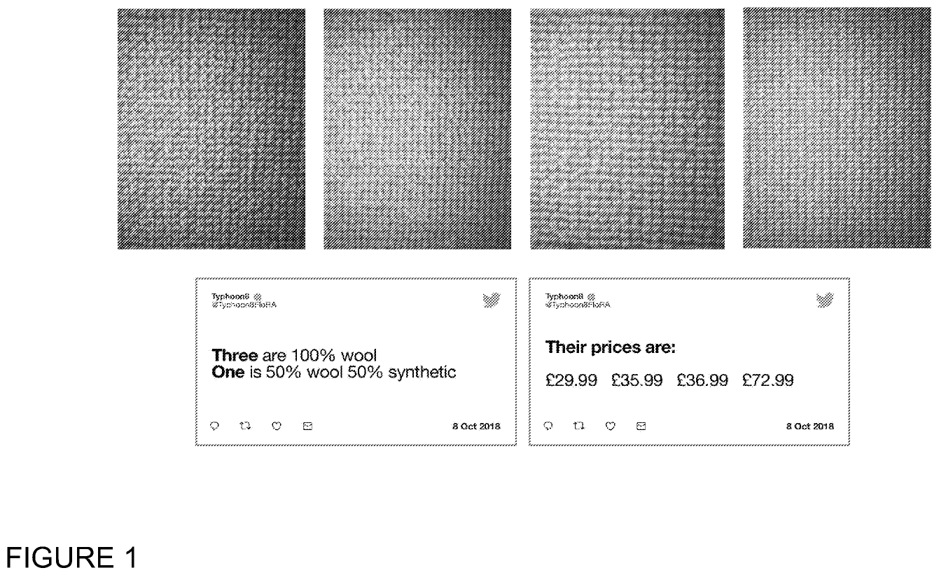

As discussed earlier, accurately classifying carpet is a challenging task as carpets come in a variety in types of material (synthetic, wool, wool mix, sisal etc), construction (Twist, Loop Berber, Saxony, Cut Loop, etc.), colour, patterns and weight (Extra Heavy, Heavy, Medium, Light, Extra Light). The difference within one category may be significant, while the difference between certain categories may be subtle. As an example, FIG. 1 shows a series of pictures of different carpets and their corresponding material types and prices.

A classification model for carpets based on computer vision/machine learning and Convolutional Neural Networks (CNN) or Deep Convolutional Neural Networks (DCNN) is developed. The DCNN sits on a server or within a mobile device such as a smartphone and can be used within an application or web browser, through which customers upload photos of the carpet or a portion of the carpet and get automatic identification of the carpet and its value immediately.

Utilising a measuring algorithm, a valuation for an area can then be calculated. CarMa, the measuring algorithm, is a simplified process to measure the square meter needed to replace the carpet, whose design was done with the purpose of serving the average policy holder, and not the professional who might need a more complex/sophisticated process. The measuring algorithm uses a two step method for calculating how many roll widths, which are typically fixed at as 4 m or 5 m, are needed to correctly fit any given room shape, multiple rooms or hall stairs and landings.

This also serves to set an industry standard to base the cost of a carpet on physical qualities as captured by the model, reducing market confusion which may result from individual outlets manipulating the product quality and price.

An end-user takes a photograph in or outside of an application running on their mobile device such as their smartphone of a clean section of carpet (with camera positioned horizontally and pointing vertically downwards) at a close and fixed distance of, for example 10 cm, with the flash on. The photograph is sent for processing to a server hosting or accessing an inference model, either locally on the device or at a remote server.

The end-user may select through the application the distance relative to the floor at which the photograph is captured, such as 10 cm or 20 cm. Alternatively the application may automatically measure the distance at which the photograph is captured and transmit the information to the server.

Once on the server, multiple crops are extracted from the captured image at different locations on the image. These are inputted to the embedded/inference model.

The model consists of:
a deep convolutional neural network, which takes an image as input and extracts a feature vector from the image, and
a fully connected deep neural network that takes the feature vector and returns a prediction in the form of a probability distribution over a set of reference carpet categories, expressing the likelihood that the input image contains a carpet of a particular category.

The model returns a prediction for each crop given as input. These predictions are then averaged in order to calculate a single prediction for the original photograph. Data relating to the top most probable categories, for example the top 2 most probable categories, are returned from the model server to the application rapidly, such as within 4 seconds or less.

### Architecture

Various general techniques of DCNN are used and an application was developed in the domain of classification of texture-based object. This serves as a baseline and guide for future applications in this domain, as most current DCNN-based applications perform simultaneous segmentation and classification for objects with a clear outline, such as packages on retailer shelf, cars, customer faces or roadside construction.

However, the model may be also applied to laminate wood flooring, natural wood flooring, bricks or furniture as the same basic principles apply.

An initial model was based on Caffe Convolutional Architecture for Fast Feature Embedding (Jia, et al., 2014). This framework was chosen for its modular implementation of layers and GPU extension. The training uses one GPU, with CUDA Deep Neural Network library (cuDNN) acceleration from Nvidia. Python interface (PyCaffe) was used to extract information such as computing confusion matrix and testing individual images.

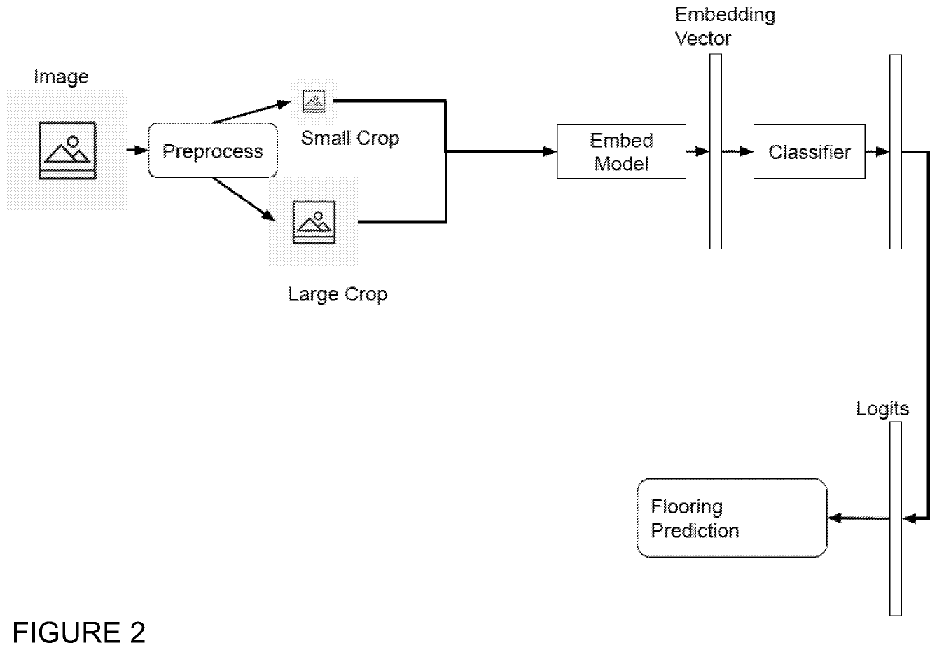

FIG. 2 shows a diagram illustrating the embedded process for flooring prediction.

The current model takes the form of a deep convolutional neural network based on the ResNet50 architecture's fully convolutional subnet in a “siamese” configuration.

Given an input image of a carpet, 2 square central crops are taken: 448-pixel at full input resolution, and (size of shortest side)-pixel, down-sampled to 448×448. These crops are then passed to a ResNext-based feature extractor, which is run on both crops independently to produce 2 feature maps. These are then average-pooled to produce 2 feature vectors, which are concatenated to form the full feature vector for the input image. This is then used as input to a fully-connected deep neural network (FC-DNN) to produce an embedding vector. The embedding vector is further processed by another FC-DNN before to produce logits for classification.

To select the top-K most likely classes, the logits are simply sorted in descending order, and the indices of the K largest are returned.

Training is structured around two phases. The first is the feature extraction subnet, composed of the 2-headed “siamese” FCN followed by the first FC-DNN. The latter consists of a learned linear matrix multiplication layer, followed by a squared exponential linear unit nonlinearity. This is trained using the triplet loss metric learning criterion, encouraging the model to describe carpet products uniquely. This is achieved by forcing feature vectors from images of the same product to be near each other, whilst encouraging feature vectors from images of different products to be far apart up to a fixed margin. The second is a classifier FC-DNN that is trained on the feature vectors of the training dataset. The network consists of a linear projection, followed by layer normalisation and leaky rectified linear units for stabilisation and nonlinearity. At this point in the training the first subnet is fixed, allowing for much faster re-training.

The training algorithm uses mini-batch stochastic gradient descent and the AdamW weight update rule to allow for stable training of the model parameters in both stages.

The training and inference algorithms are implemented in the Pytorch framework.

The training algorithm is structured to take advantage of multiple GPUs for parallelising across data examples.

### 1. Carpet Recognition

### 1.1 Data Categorisation

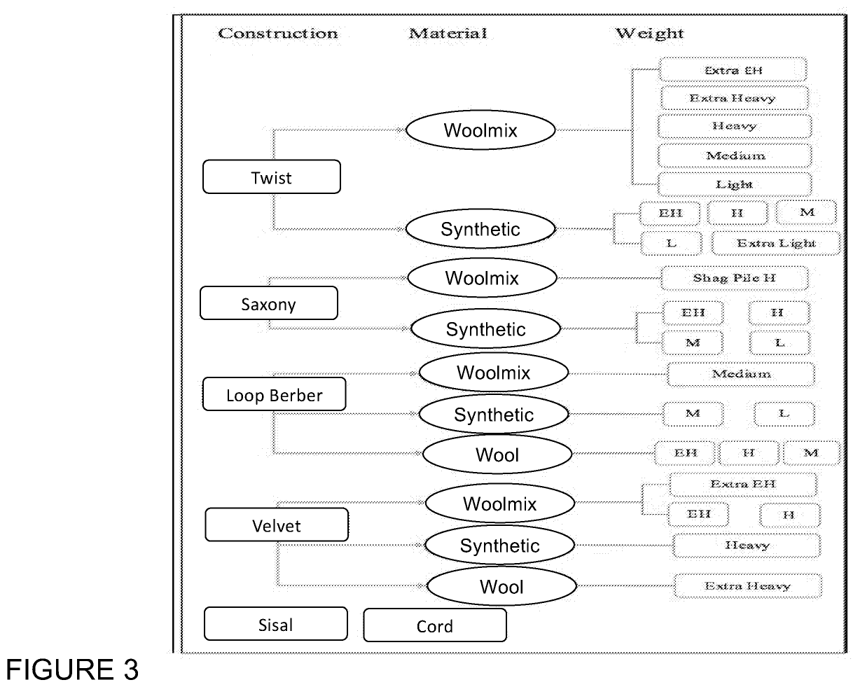

FIG. 3 shows a diagram illustrating carpet categories. The physical carpets are organised and then categorised by type, weight, pile content, ply and value.

High level categories are set as Generic and Unique. Generic carpets are classified as those without distinguishable pattern. Unique are classed as those with a distinguishable pattern. Every unique pattern has its own category and is labelled with the name given it by the manufacturer.

Generic carpets are first divided into synthetic carpets and wool mix. Then subdivided into type for example twist pile, saxony, berber, cut and loop. These are then subdivided into lightweight, medium weight and heavyweight where appropriate. These can be divided further where necessary into super lightweight, light to medium weight etc.

### 1.2 Data Collection and Labelling

Images were taken of carpets using smart phones with high resolution, flash light and held horizontally at a fixed distance of approximately 10 cm for generic unpatterned carpets and at knee height, roughly 60 cm, for patterned carpets.

Each carpet category, e.g. Synthetic Twist medium weight 2 ply £15.99, was then photographed by a range of available devices such as Samsung and Apple phones and tablets with flash at 10 cm for plain carpets and 60 cm for patterned. The datasets per category range between 500 to 10,000 photos—each photo should preferably be a high resolution image; these are currently 2.4 Mb size or greater.

Those photographs are then labelled/tagged by parameters or attributes such as type, weight, pile content, ply and value.

### 1.3 Data Cleansing and Training

### 1.3.1 Confusion Matrix

To analyse where the model is making mistakes, a confusion matrix was produced by running images through the model and comparing the output with true label. This corresponds closely to how human discern carpets.

As the confusion matrices were expensive to calculate, they were stored as Numpy files during the training process and displayed using a different script for later analysis. Initially for speed purpose, only the centre crop was used in testing. Later a representative sample of the four corners and centre crop, together with their mirror images, was used and produced better result. Using more random crops improved performance still, but insignificant beyond 40 crops.

### 1.3.2 Two-Stage Training for Large Database

The approach to counter this was to extract a small and symmetric sample base from the entire database for first-stage training. Training directly on the new, large and asymmetric database yielded wild fluctuation and did not converge as before. A possible explanation is that despite the dynamic shuffling, the model encounters too few of the categories during one iteration and moves too much in the local optimization, before encountering something completely different in the next iteration. While batch normalization and averaging loss help in retaining past information, and lower base learning rates were experimented to avoid drastic move, the model still failed to see the entire picture.

### 1.3.3 Frequency-Weighted Loss for Asymmetric Database

While the two-stage training achieved an improvement in average accuracy, the model still appeared biased towards categories with more samples. A rectifying measure was taken to weight the loss function with relative frequency. The weights are pre-calculated and set as parameter in the Softmax with Loss layer. The source code for this layer (.cpp file for CPU implementation, and .cu file for GPU implementation) was then modified to multiply the loss for each category with its weight.

Training directly on the large database using this weighted loss again was not successful. Two-stage training was then still used, and weighted loss was turned on for the second stage. Apart from calculating the average accuracy, as mean accuracy was calculated as an average of per category accuracy. By tracking the discrepancy between these two, it was observed that the performance became less skewed among categories.

Combining the training techniques, the final model achieved over 90% test accuracy.

### 2. [Backend] Technology/Architecture

### 2.1 Architecture to Serve the Algorithm

Ubuntu script with GUI for a single user is able to utilise the architecture for training and testing of the Client's carpet image database and upload the resulting trained model to the Client's AWS server. A GUI program operating on Ubuntu only has the following functionality:
wraps around the CAFFE deep learning framework;
pick a dataset directory for training;
pick a dataset directory for testing;
pick a save location for the trained model weights;
pick a model specification;
setup a training run by selecting parameters;
run a training run and record performance (classification accuracy) over time on train and test datasets;
when completed, display a graph of performance over the training run.

A server program for running test images on a trained model, comprising an API for uploading an image over the internet and retrieving a classification result:
built in python flask (a lightweight web framework);
provides a REST API for classification requests to the production server;
wrapper around CAFFE deep learning framework;
may require login credentials;
may save uploaded images.

A website to connect to the Client's server program, upload an image and display a resulting classification.
is the front-end of the production server i.e. hosted on the production server;
accessed by http;
provides a simple interface for: registration, login, uploading an image, and getting back the top N classes predicted by the server.

### 2.2 Other Back End Processes

These include but are not limited to: output to back end CRM and voucher, mandate or fulfilment process.

The application methodology may include CNN capability, either at the server level or through a phone App utilising CNN on the mobile phone. When the app uses a CNN model directly sitting on the mobile phone, the whole process may be run offline.

### 3. Application Walk Through Example

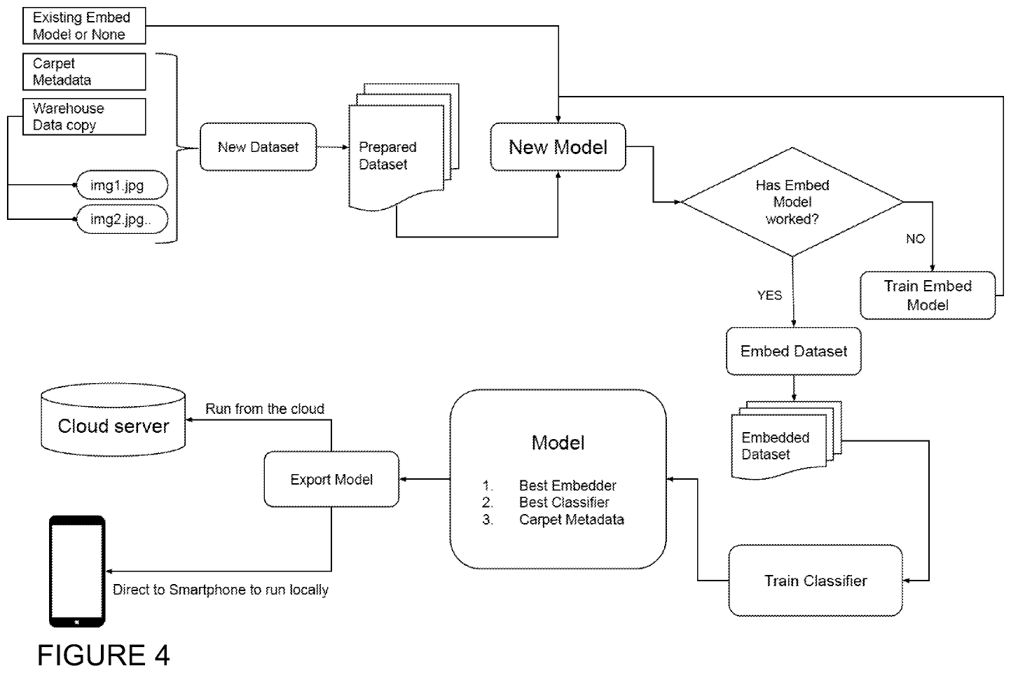

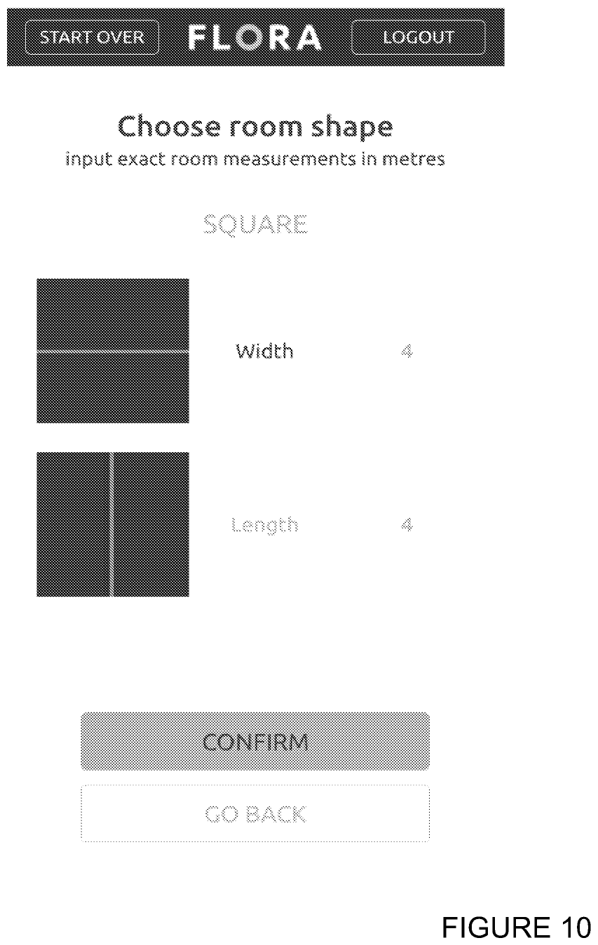

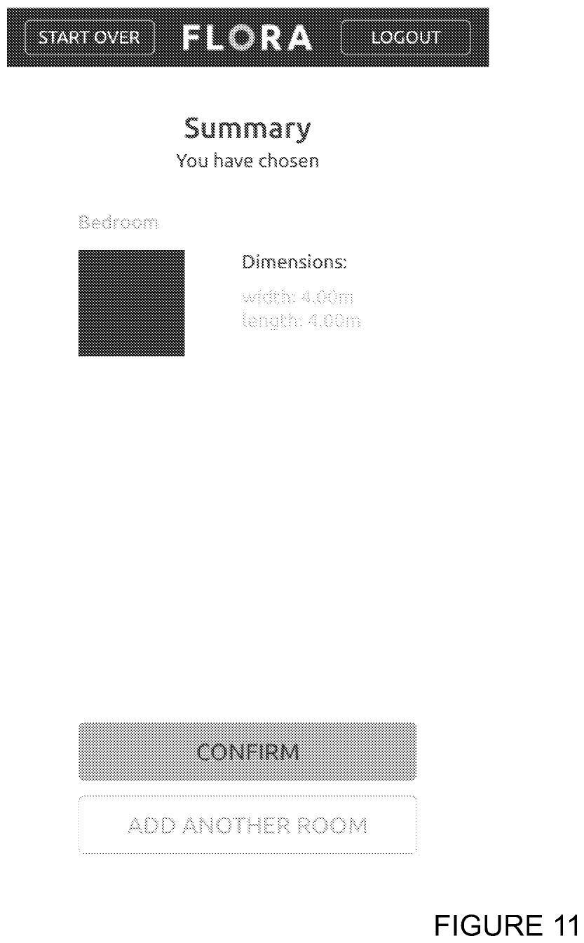

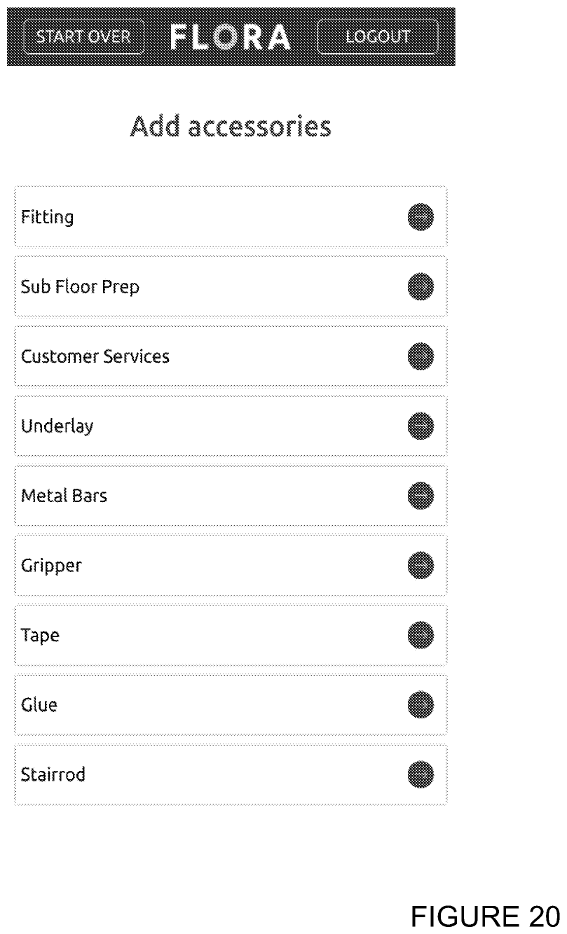

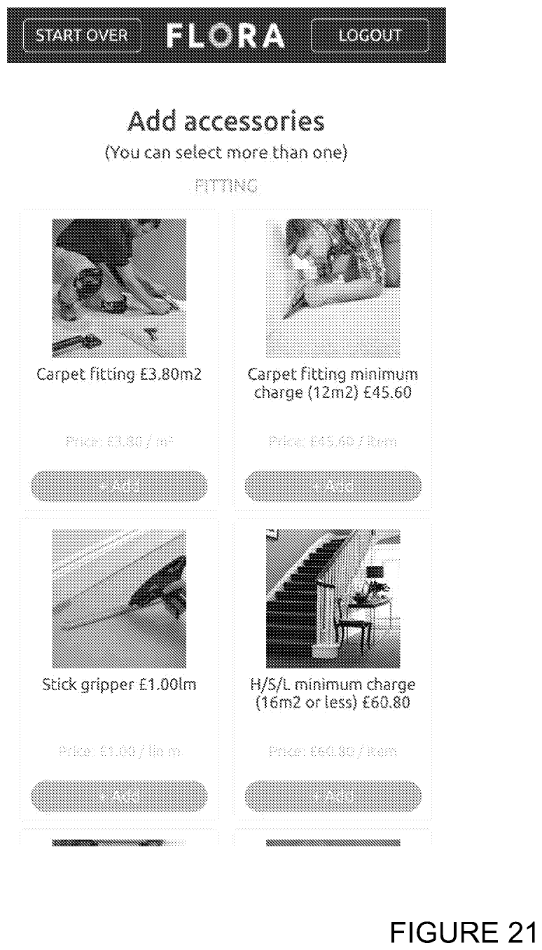

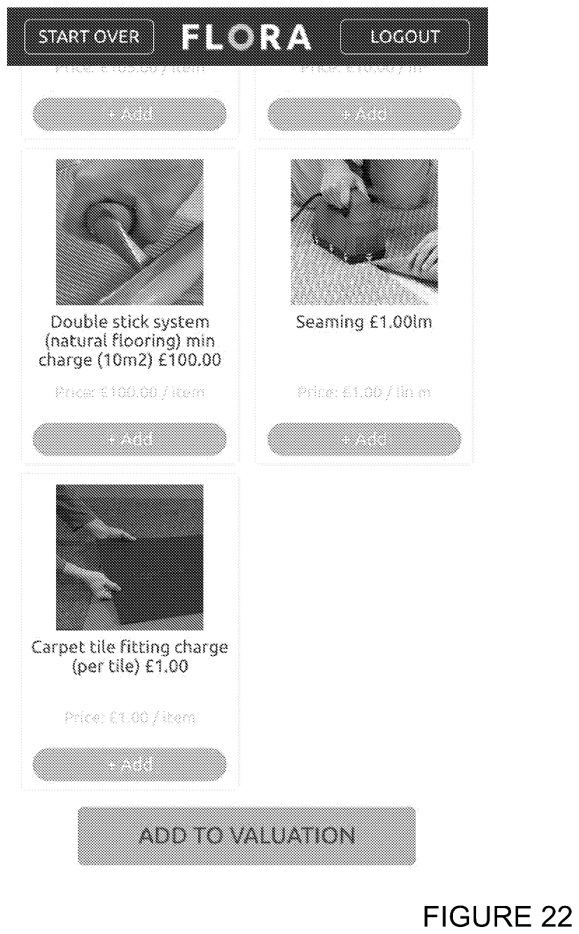

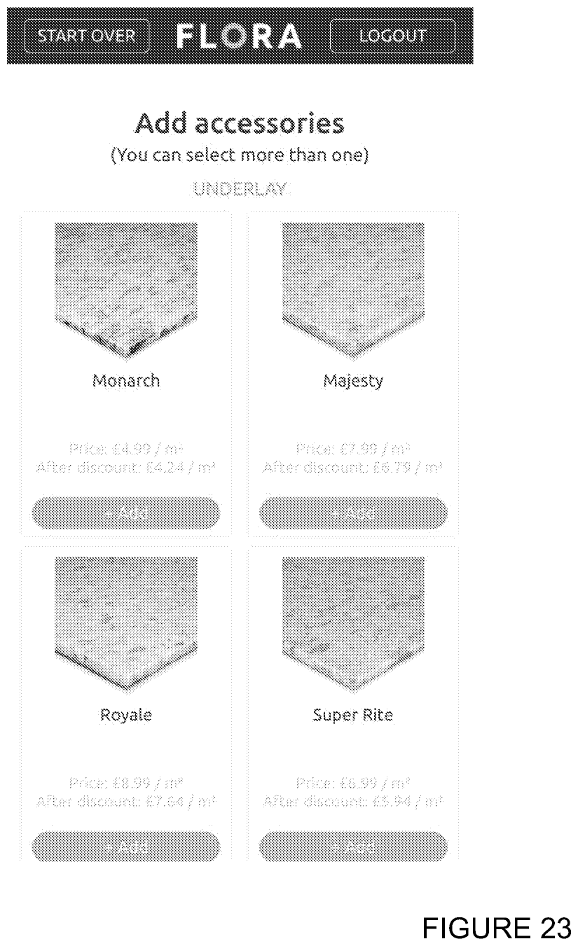

FIGS. 3 to 31 are screenshots of an examplary application illustrating how an end-user may use the application running on their mobile device and providing the following:
Carpet recognition;
Carpet length calculation;
Carpet valuation;
Add-ons to the replacement/instalment;
Order the carpet (electronic, traditional).

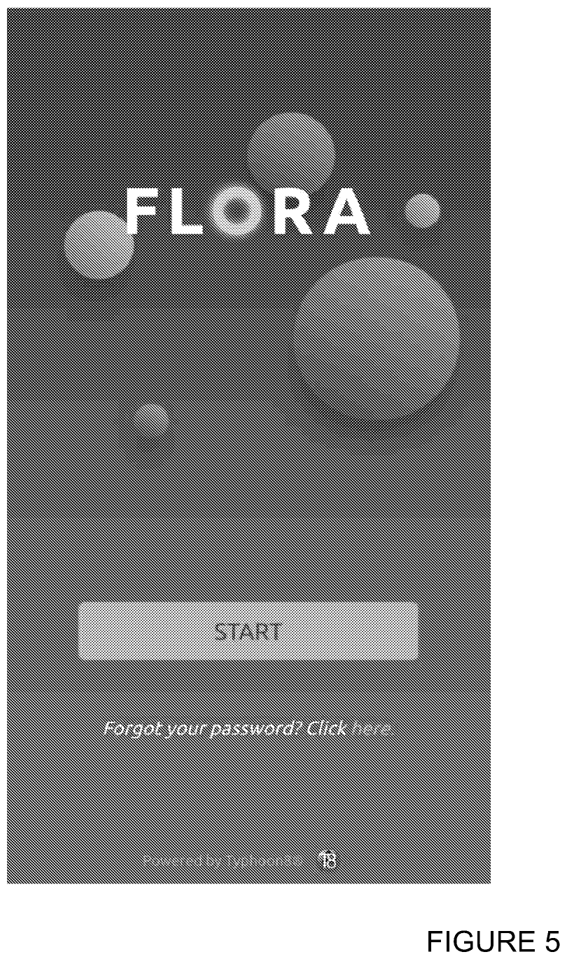

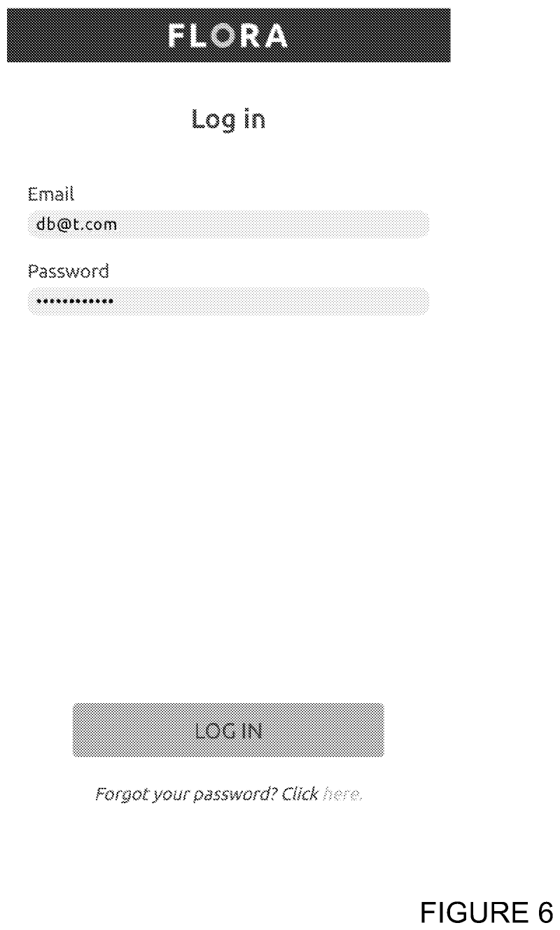

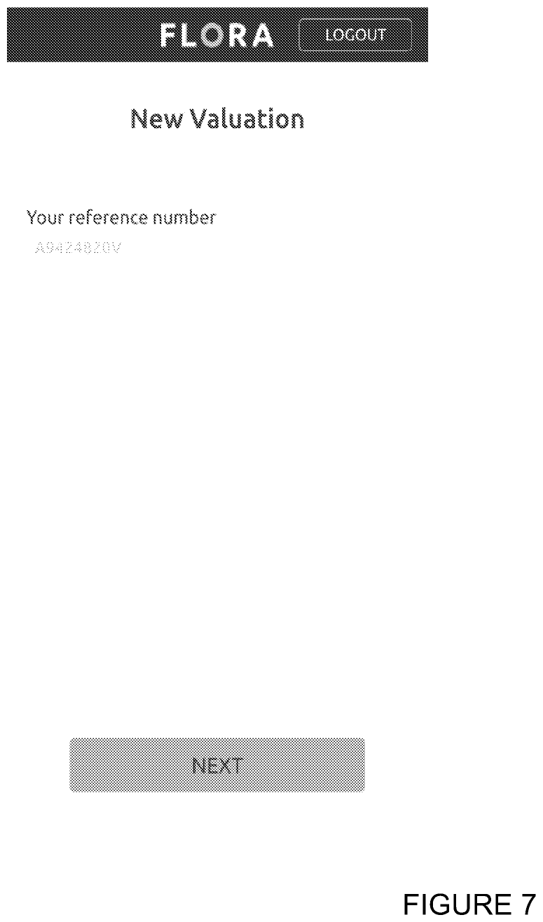

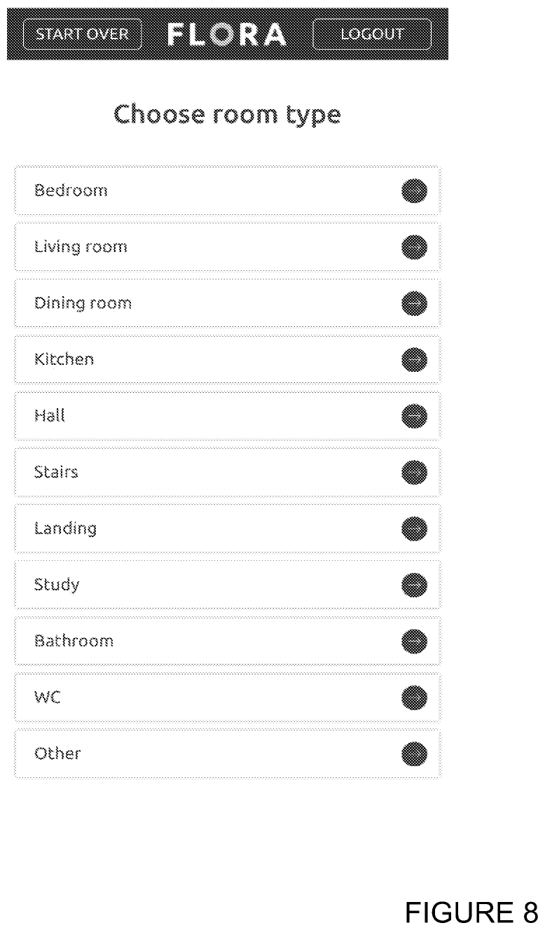

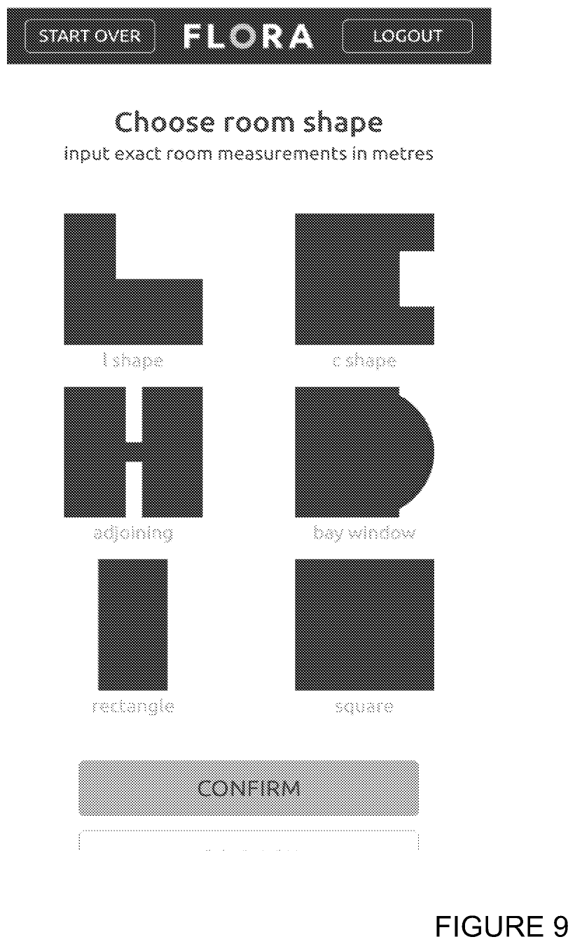

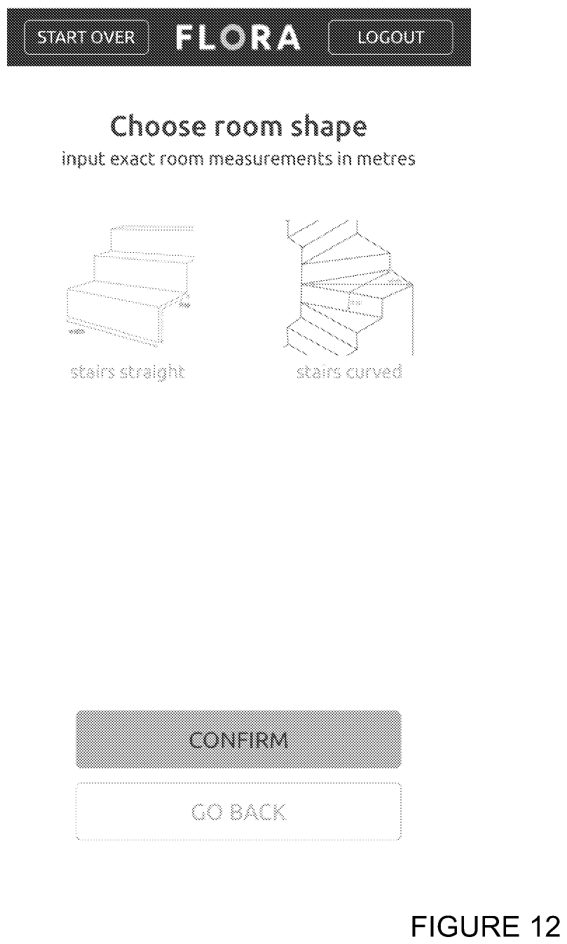

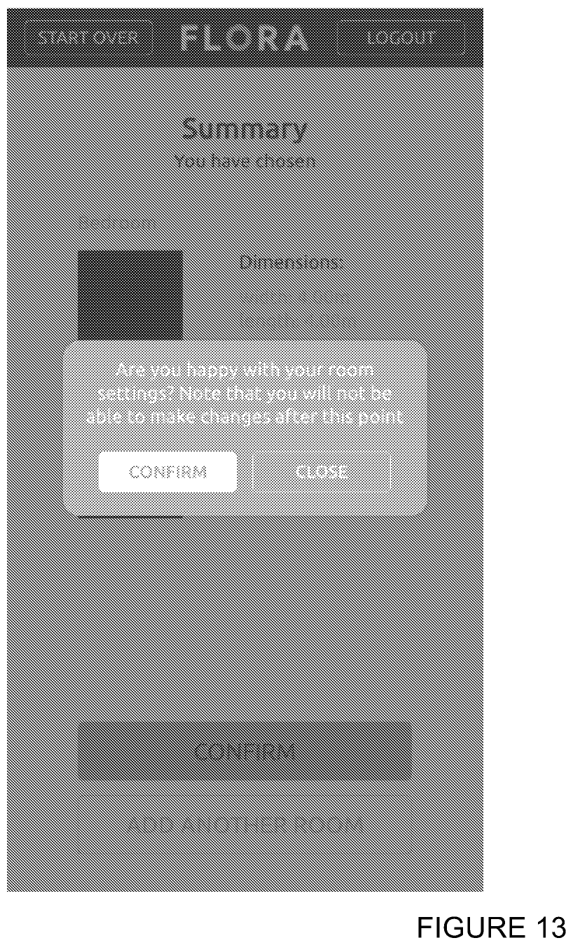

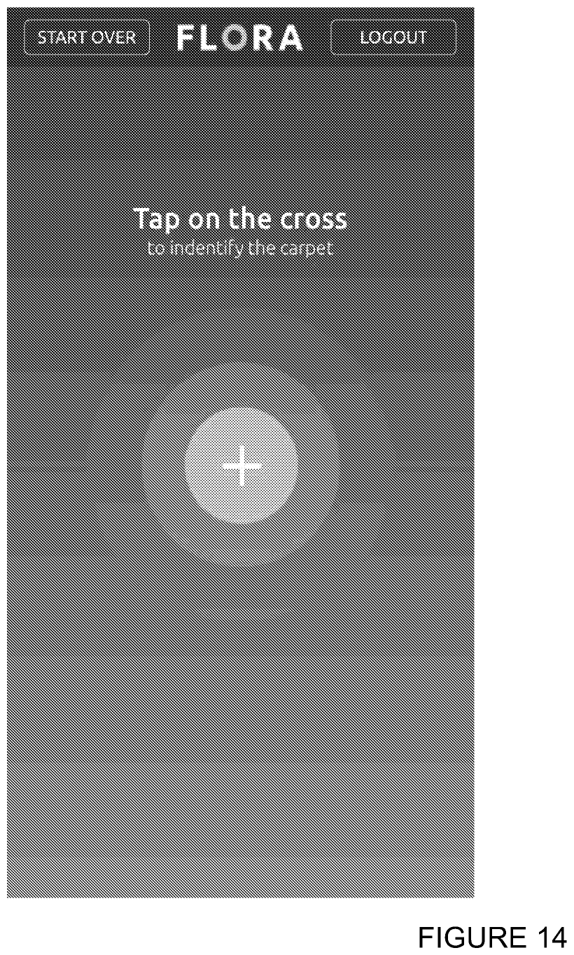

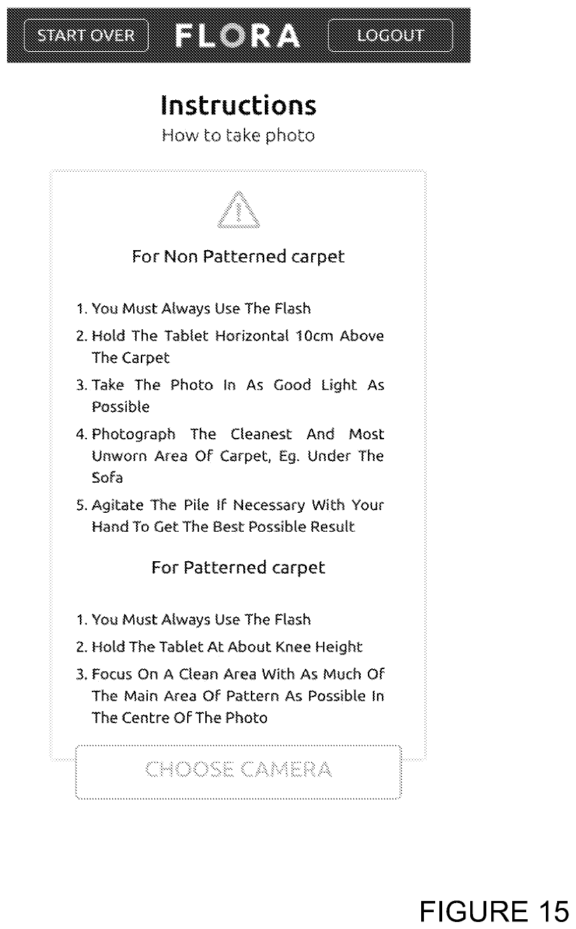

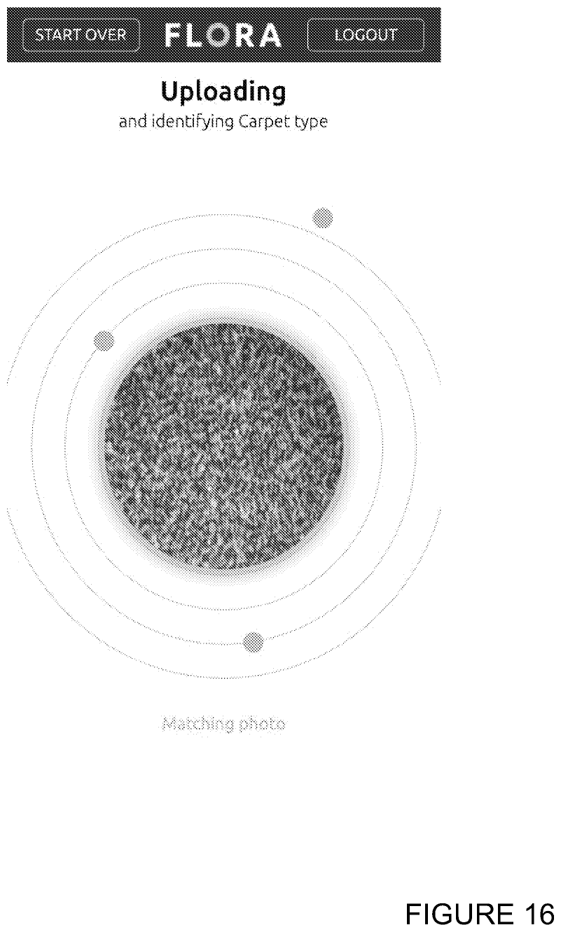

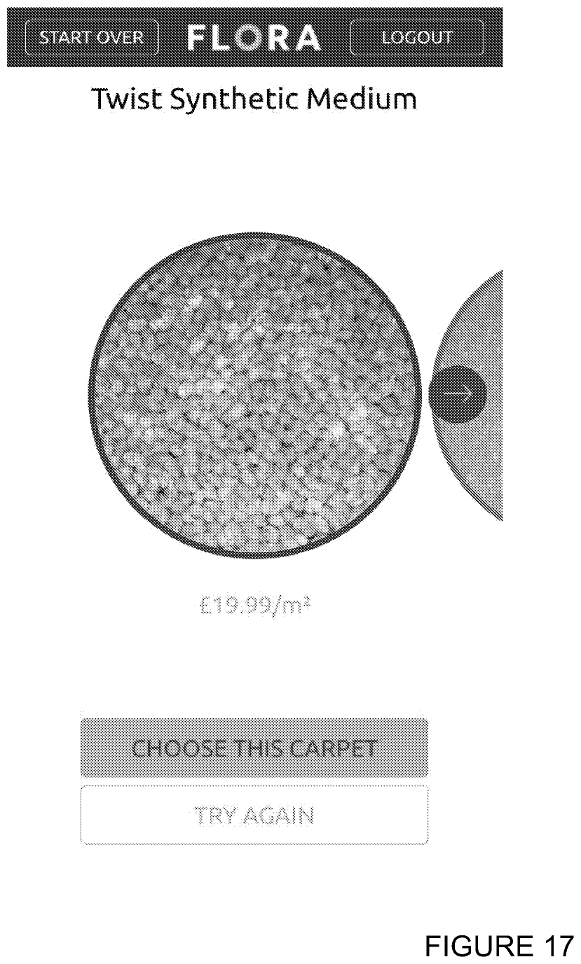

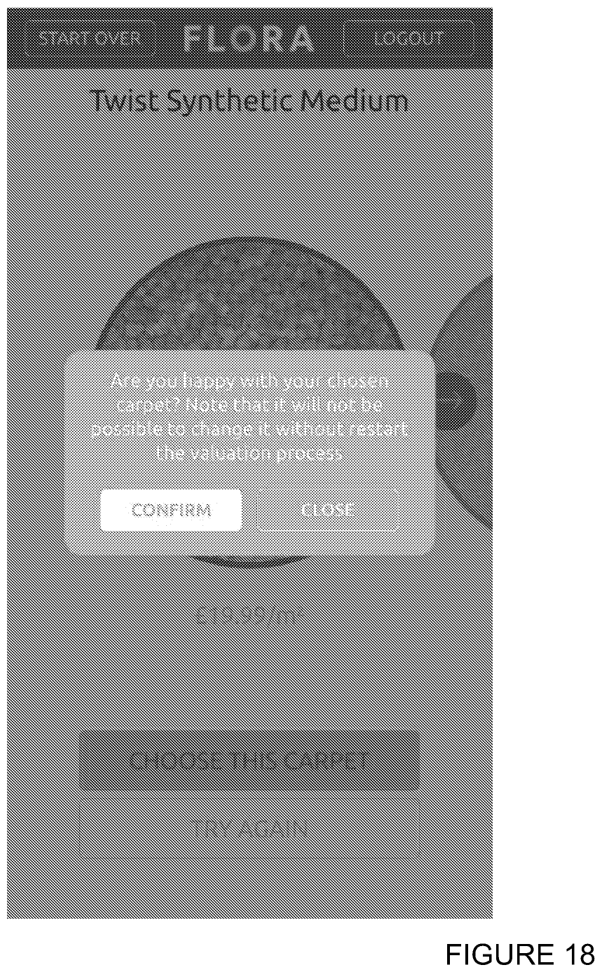

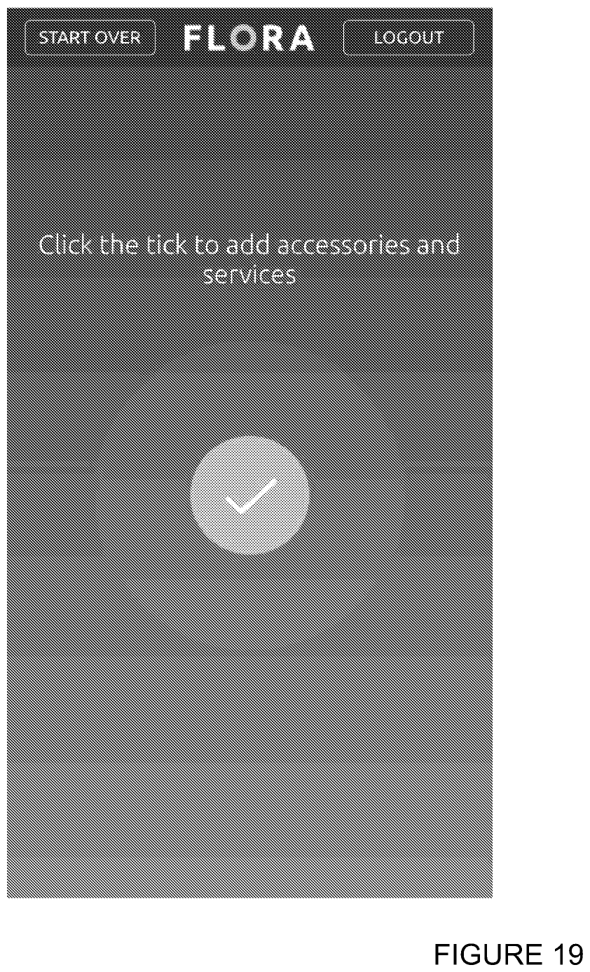

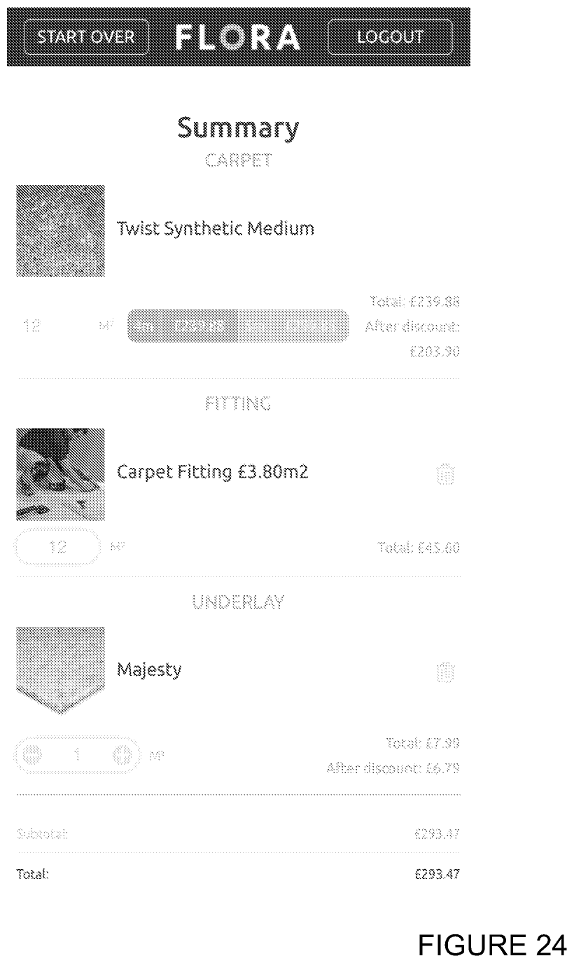

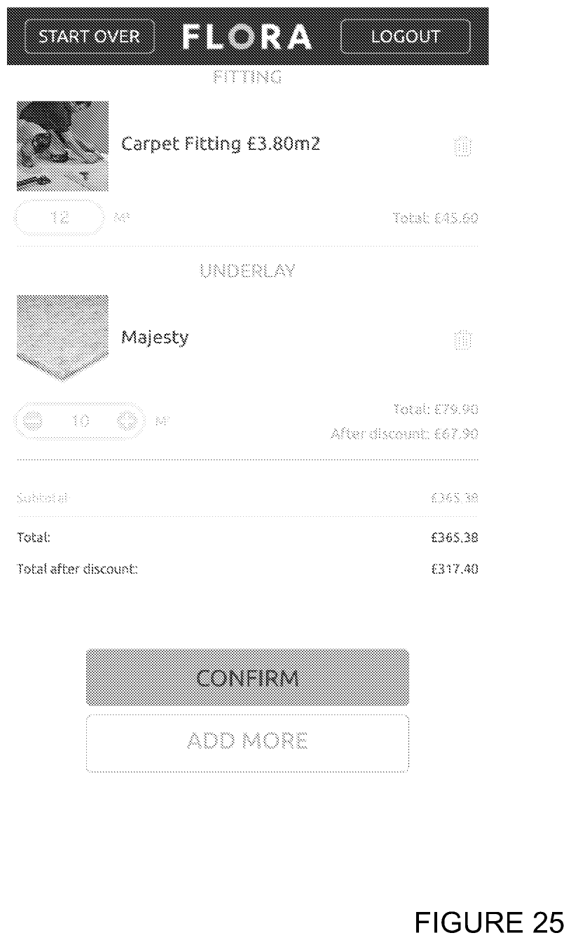

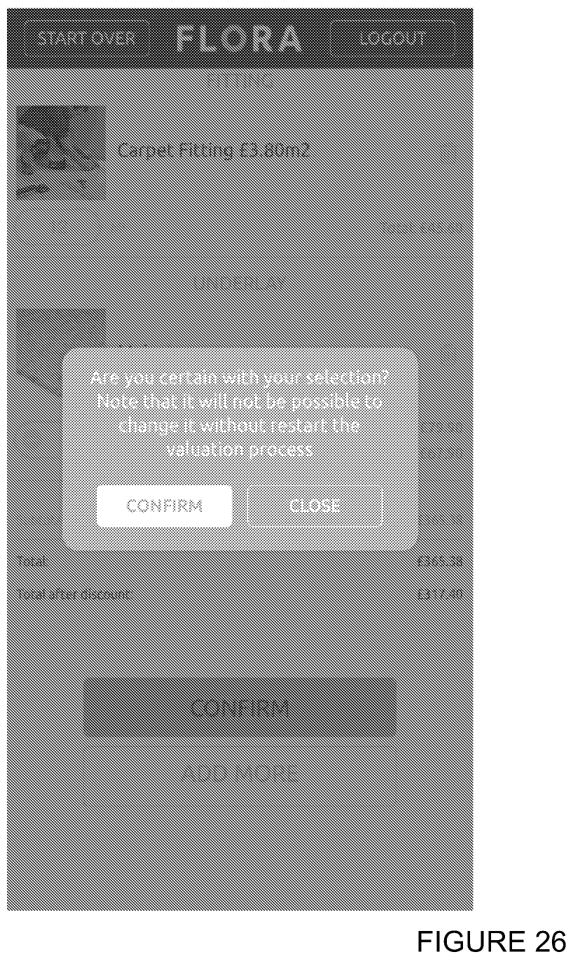

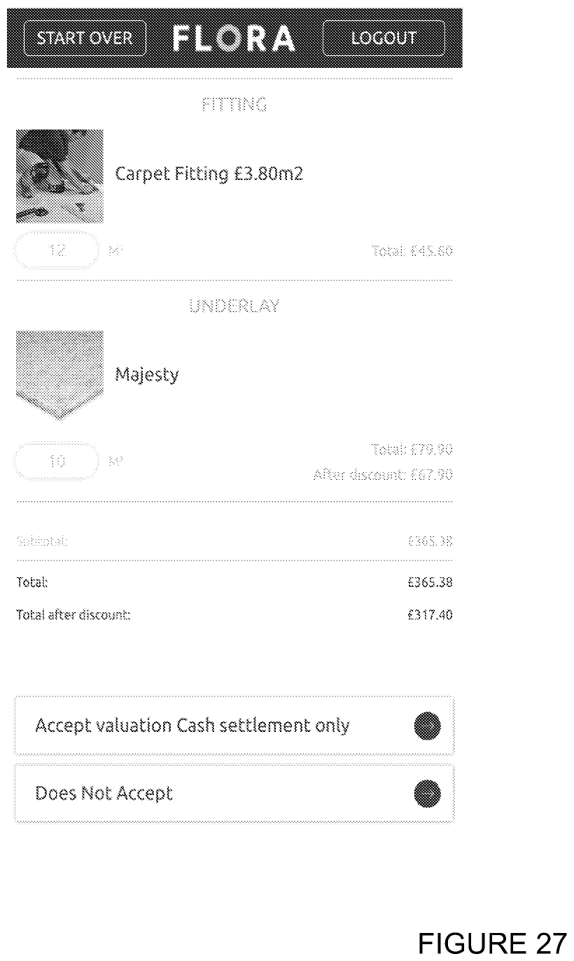

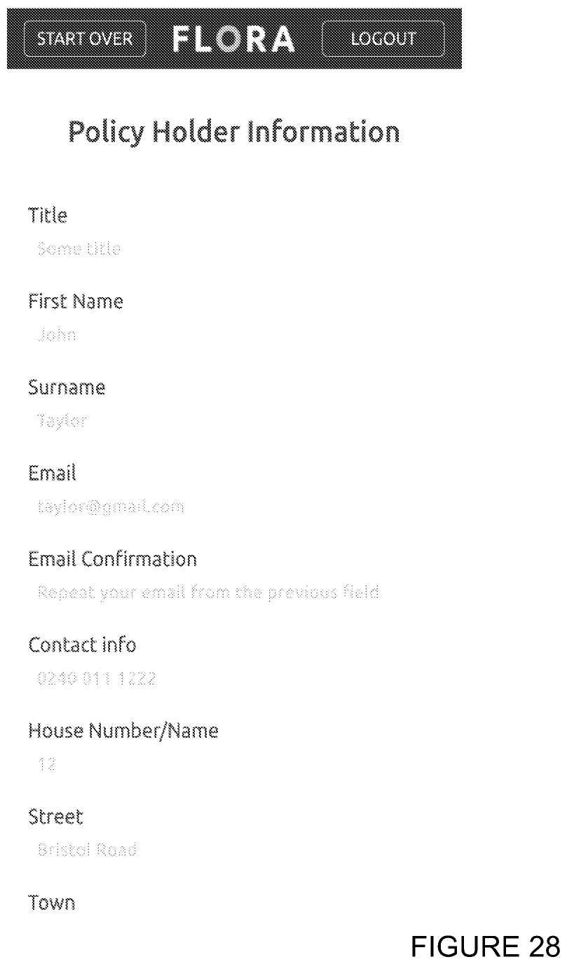

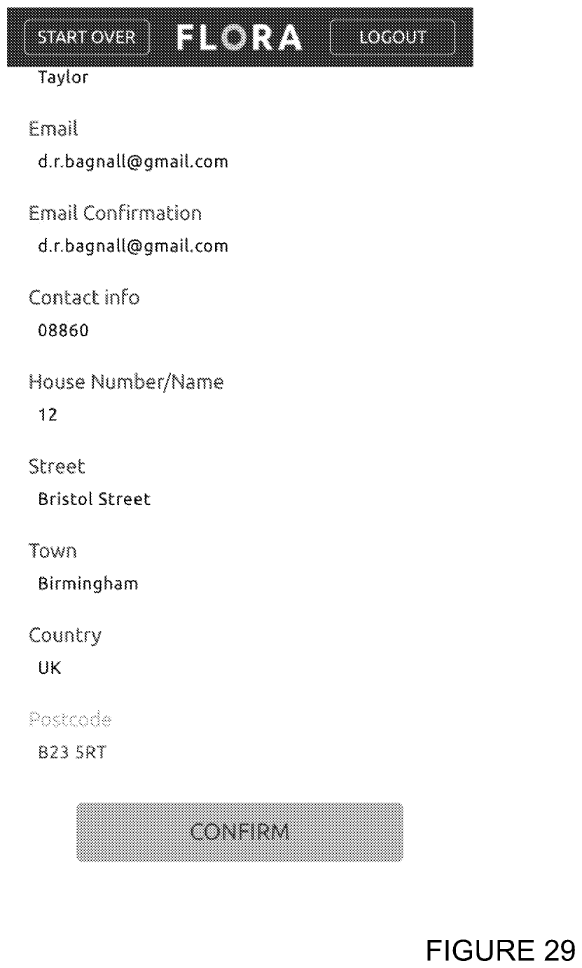

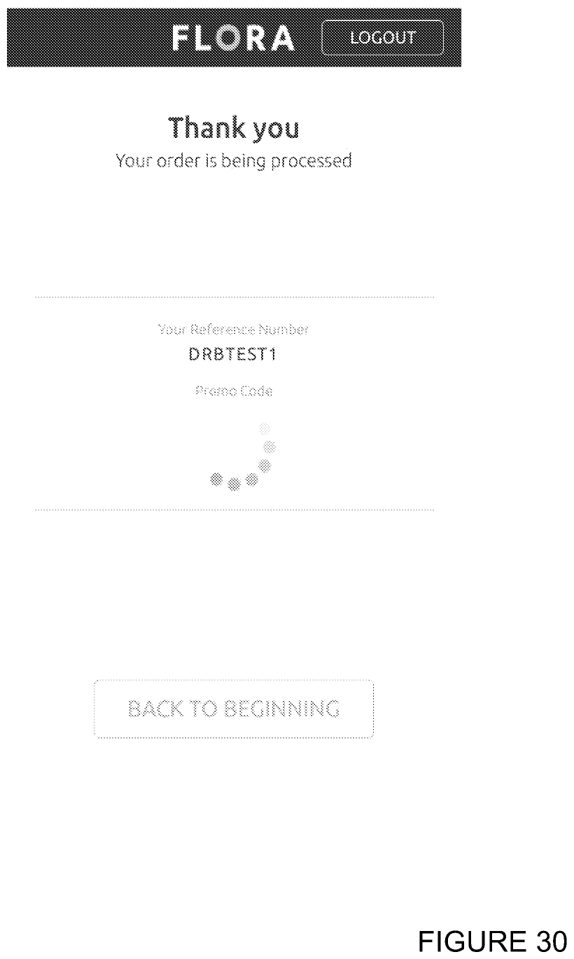

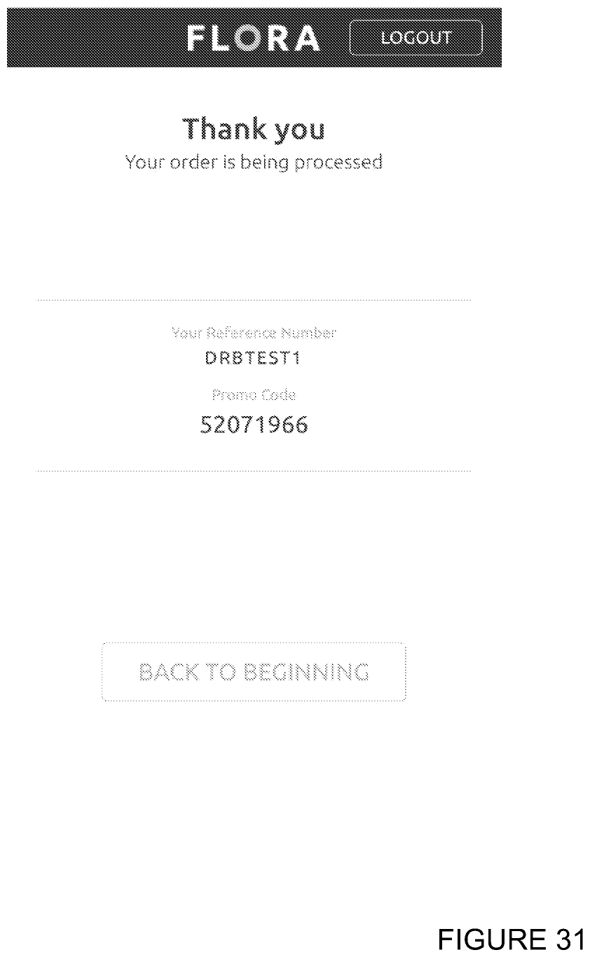

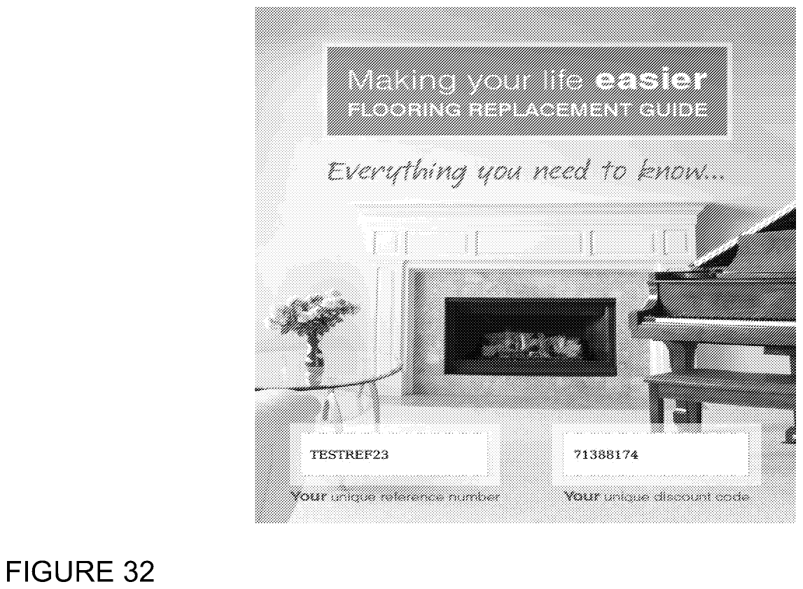

The end-user launches the Flora application through an app or web browser or other messaging channel running on their mobile device such as a smartphone or other web-connected equipment as shown in FIG. 5, and signs onto the application (FIG. 6). The user inputs a reference number and hits ‘next’ (FIG. 7) and then selects a room type (FIG. 8). In FIGS. 9 to 11 the user selects the shape of the room, confirms the selection and inputs corresponding measurements of the room. The user may also be given the choice between straight stairs or curved stairs as shown in FIG. 12. In FIG. 13, the application displays the entered measurements and prompts the user to confirm whether or not the measurements are correct. The Carma Algorithm then calculates the amount of Carpet needed for both 4 m wide carpet and 5 m wide carpet and stores the information. In FIG. 14, the user is then asked to prepare for taking a photograph of the carpet they want to evaluate. A set of instructions on how to take the photograph depending on the type of carpet is then displayed to the user as shown in FIG. 15. The user is then asked to select the camera. The mobile device's camera is automatically opened with the flash turned on. In FIG. 16, the user takes the required photo at a fixed height. The photo is then transmitted to a cloud server for processing. The server then transmits the estimated carpet category and its value. As shown in FIG. 17, two images are displayed to the end-user on the application as suggestions as to what the carpet is, based on learned data, alongside carpet type and value. The user then confirms if they are happy with the selected carpet, as shown in FIG. 18. As shown in FIGS. 19 to 23, the user may also choose additional types of accessories or services to add to the valuation. An editable summary page is then displayed to the end-user listing the cost of each individual chosen accessory or service including a total estimated cost as shown in FIG. 24. The user can then choose to confirm the valuation (FIG. 25). Once the user has confirmed and ‘locked in’ their valuation they may then choose to issue a cash settlement for an amount agreed with the policy holder as shown in FIG. 26. The user can also choose to accept or not the valuation cash settlement as seen in FIG. 27. In FIG. 28, the policy holder or the user fills in the relevant details so that a ‘discount’ voucher can be emailed to the policy holder. FIG. 29 shows a further page in which the policy holder can confirm the details previously filled in. As shown in FIG. 30, Flora then processes the information, records it in a back-end database and generates a unique code that is inserted into the Voucher with the reference number as shown in FIG. 31. Relevant information is also immediately emailed to the policy holder. FIG. 32 shows a page displaying a voucher sample.

### 4. Use Cases Examples

In addition to handling an insurance policy claim, further use case examples exist.

### Process Flow: Home Insurance Application

Today, insurers often have to face a risk associated with the tradeoff between fast decision taking and lack of speedy ways to accurately value flooring. When contracting home insurance, policy holders are asked to include their valuables in the application in order to get coverage for them. However, flooring, being one of the most valuable items covered in the insurance, is unknown to the insurer. With our technology, insurers could ask the applicant to send an image and certain size/shape characteristics to assess risk when calculating home insurance premiums.

### Carpet or Flooring Type Comparison

An end-user may take or upload a picture of flooring or carpet they wish to buy on an application or web-browser. Using the methods describe above, the picture is analysed and the type of flooring is automatically recognised. The application may then display to the end-user a list of similar type of flooring available for purchase along with their type and value.

Additionally, the application may also display a list of nearby shops in which similar type of flooring is available. The application may also display the top most appealing deal possible for the end-user. Depending on pre-defined parameters, such as how often an end-user has spent looking for a particular flooring type or whether the end-user is located within a certain distance from a specific shop, a discount may also be automatically provided to the end-user for purchasing the product within a specific time limit.

### 5. Summary of Key Concepts

Note that all Key Concepts A onwards can be combined with any other Key Concept B onwards; each Key Concept may be a novel concept. All ‘Optional’ features can be combined with any Key Concept A onwards and any other ‘Optional’ feature. Each ‘Optional’ feature may also be an independently novel concept.

### A. Method of Providing Cost Estimate

A machine learning based method of providing a cost estimate for a floor repair or replacement service, the method including the steps of:
(i) receiving an image of a portion of a floor to be repaired or replaced from an end-user's application or web browser or web app running on the end-user's device;
(ii) configuring one or more processors to generate, based on the received image, a cost estimate for the floor repair or replacement service using a machine learning model; and
(iii) providing the cost estimate to the end-user's application or web browser or web app.

### Optional:

step(i) is performed at a server;
step(ii) includes a classifier machine learning approach which classifies the floor according to pre-defined categories.
classifier predicts the likelihood that the received image is an image of the floor belonging to one or more pre-defined categories.
classifier outputs the top most likely categories and provides the list of most likely categories to the end-user's application or web-browser or web app.
categories include one or more of: material type, construction type, colour, pattern, weight, thickness or manufacturer.
multiple cropped images are extracted from the received image and inputted to a first neural network, such as a deep convolutional network.
the first neural network outputs a feature vector from each inputted cropped image.
feature vectors are inputted into a second neural network, such as a fully connected deep neural network which outputs a score corresponding to the likelihood that a cropped image is an image of a floor that belongs to the one or more pre-defined categories.
scores for each cropped image are averaged.
computer vision algorithm determines the probabilities that the received image belongs to the top most likely categories outputted by the second neural network.
outputs from the classifier and the computer vision algorithm are combined in order to generate the list of most likely categories.
method includes the step of training the machine learning model using a dataset of pre-labelled floor images in order to configure the machine learning model to predict the likelihood of the image to belong to pre-defined categories.
classifiers are trained by training multiple models with specific subset of a training dataset including pre-labelled floor images and comparing the predictive accuracy of the different training models.
method includes the step of displaying to the end-user the top most likely categories and their corresponding cost estimate, such as the top 2 categories.
end-user confirms or selects via the application or web browser or web app a category out of the top most likely categories displayed.
end-user inputs via the application or web browser or web app the dimensions or shape of the flooring area that needs to be repaired or replaced;
a measuring algorithm determines the square meter needed for the floor repair or replacement service.
image is captured at a fixed predetermined distance relative to the floor;
image is captured with the flash on;
end-user's device automatically determines the distance at which the image was captured;
cost estimate is provided to the end-user's application or web-browser instantly or near-instantly such as in less than 4 seconds.
method further includes the step of providing the cost estimate to a service provider's device;
end user's device is a mobile device such as a smartphone, tablet, laptop computer or any other mobile device;
end-user is able to request a cost estimate for further services or accessories in addition to the floor repair or replacement service, such as fitting, sub-floor preparation, underlay, metal bars, gripper, tape, glue, stair rod or any other services or accessories.
one or more processors are located at a remote server;
one or more processors are located in the end-user's device;
end-user is able, via the application, to communicate directly with a service provider.
end-user is able, via the application, to make a money payment to a service provider.
method includes the step of providing a CRM or voucher or mandate or any other fulfilment process corresponding to the requested service to the end-user's application or web browser or web app.
floor is any type of flooring such as carpet, brick, rugs, tile, stone or laminate.
floor is a carpet and the measuring algorithm estimates the number of rolls of carpet needed based on the roll's width.
carpet is classified by material type such as synthetic, wool, wool mix or sisal.
carpet is classified by construction such as twist, loop berber, saxony, cut loop.
carpet is classified by patterns.
carpet is classified by weight such as lightweight, medium weight or heavy weight.
carpet thickness is automatically determined.
method is performed without requiring an expert assessment.
method is performed without requiring a physical analysis of a floor sample.
method is used for home insurance application in which the cost estimate is used to calculate a home insurance product for the end-user.

A machine learning based system for providing a cost estimate for a floor repair or replacement service, the system comprising one or more processors configured to:
(i) receive an image of a portion of the floor to be repaired or replaced from an end-user's application or web browser or web app running on the end-user's device;
(ii) generate based on the received image a cost estimate for the floor repair or replacement service using a machine learning model; and
(iii) provide the cost estimate to the end-user's application or web browser or web app.

### Optional:

the system is configured to implement a method of any of aspect of concept A.

A server configured to provide a cost estimate for a floor repair or replacement service, the server arranged to:
(i) receive an image of a portion of the floor to be repaired or replaced from an end-user's application or web browser or web app running on the end-user's device;
(ii) generate a cost estimate for the repair or replacement of the floor using a machine learning model; and
(iii) provide the cost estimate to the end-user's application or web browser or web app.

### Optional:

the server is arranged to perform a method of any of aspect of concept A.

### B. End-User Application to be Used on Site by a Surveyor or Directly by a Policy Holder

An application providing an end-user with an interface module configured to provide a cost estimate for a floor repair or replacement service, in which the end-user inputs an image of a portion of a floor to be repaired or replaced into the interface module and in which one or more processors, coupled to the interface module, are configured to generate, based on the received image, a cost estimate for the floor repair or replacement service using a machine learning model.

C. Matching a Policy Holder with a List of Service Providers

Method of matching an end-user requesting a service to a list of service providers, the method comprising the steps of:
(i) receiving by a computer device a service request for floor repair or replacement from an end-user, such as a policy holder, the service request including an image of the floor to be repaired or replaced;
(ii) configuring one or more processors to generate, based on the service request, a cost estimate for the floor repair or replacement service using a machine learning model;
(iii) matching the end-user to a list of service providers based on the service requested, and providing the list of service providers to the end-user.

### Optional:

method includes the end-user selecting a service provider using the computer device.
the end-user directly places an order for the requested service on the computer device.
end-user places an order for the requested service through traditional channels like mandate and direct fulfilment.
end-user is able, via the computer device, to communicate directly with a service provider.
end-user is able, via the computer device, to make a money payment to a service provider.

### D. Carpet Classification

A machine learning based method for recognising flooring type based on an image, comprising the steps of receiving an image of a floor and configuring one or more processors to predict the floor type or attribute using a classifier machine learning approach.

### Optional:

floor type or attribute is one or more of the following: material type, construction type, colour, pattern, weight, thickness or manufacturer.
classification score assigned to an image is stored in a database.
database is accessed for subsequent use in image classification.

### E. End-User Application for Comparing Floor Type

An application providing an end-user with an interface module configured to recognise flooring type or attribute based on an image, in which the end-user inputs an image of a portion of a floor into the interface module and in which one or more processors, coupled to the interface module, are configured to predict the floor type or attribute using a classifier machine learning approach, and in which the interface module is configured to display the predicted floor type or attribute to the end-user.

### Optional:

Floor type or attribute is one or more of the following: material type, construction type, colour, pattern, weight, thickness or manufacturer.
The interface module displays a list of similar type of floors available for purchase.
the interface module displays a list of nearby shops in which similar type of floors are available, based on the geo-location of the end-user.
The interface module automatically displays a discount to the end-user for purchasing a similar type of floor.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A machine learning based method of providing a cost estimate for a floor repair or replacement service, the method including the steps of:
(i) receiving an image of a portion of a floor to be repaired or replaced from an end-user's application or web browser or web app running on the end-user's device;
(ii) configuring one or more processors to generate, based on the received image, a cost estimate for the floor repair or replacement service using a machine learning model; and
(iii) providing the cost estimate to the end-user's application or web browser or web app.

2. The method of claim 1 in which step(i) is performed at a server.

3. The method of claim 1 in which step(ii) includes a classifier machine learning approach which classifies the floor according to pre-defined categories.

4. The method of claim 1 in which a classifier predicts the likelihood that the received image is an image of the floor belonging to one or more pre-defined categories.

5. The method of claim 3 in which a classifier outputs the top most likely categories and provides the list of most likely categories to the end-user's application or web-browser or web app.

6. The method of claim 3 in which categories include one or more of: material type, construction type, colour, pattern, weight, thickness or manufacturer.

7. The method of claim 1 in which multiple cropped images are extracted from the received image and inputted to a first neural network, such as a deep convolutional network.

8. The method of claim 7 in which the first neural network outputs a feature vector from each inputted cropped image in and which feature vectors are inputted into a second neural network, such as a fully connected deep neural network which outputs a score corresponding to the likelihood that a cropped image is an image of a floor that belongs to the one or more pre-defined categories.

9. (canceled)

10. The method of claim 8 in which scores for each cropped image are averaged.

11. The method of claim 3 in which a computer vision algorithm determines the probabilities that the received image belongs to the top most likely categories.

12. The method of claim 11 in which outputs from the classifier machine learning approach and the computer vision algorithm are combined in order to generate the list of most likely categories.

13. The method of claim 1 in which the method includes the step of training the machine learning model using a dataset of pre-labelled floor images in order to configure the machine learning model to predict the likelihood of the image to belong to pre-defined categories.

14. The method of claim 3 in which classifiers are trained by training multiple models with specific subset of a training dataset including pre-labelled floor images and comparing the predictive accuracy of the different training models.

15. The method of claim 1 in which the method includes the step of displaying to the end-user the top most likely categories and their corresponding cost estimate, such as the top 2 categories.

16. The method of claim 1 in which the end-user confirms or selects via the application or web browser or web app a category out of the top most likely categories displayed.

17. The method of claim 1 in which the end-user inputs, via the application or web browser or web app, the dimensions or shape of the flooring area that needs to be repaired or replaced.

18. The method of claim 1 in which a measuring algorithm determines the square meter needed for the floor repair or replacement service.

19-20. (canceled)

21. The method of claim 1 in which the end-user's device automatically determines the distance at which the image was captured.

22. The method of claim 1 in which the cost estimate is provided to the end-user's application or web-browser instantly or near-instantly such as in less than 4 seconds.

23. The method of claim 1 in which the method further includes the step of providing the cost estimate to a service provider's device.

24. The method of claim 1 in which the end user's device is a mobile device such as a smartphone, tablet, laptop computer or any other mobile device or web-connected equipment.

25. The method of claim 1 in which the end-user is able to request a cost estimate for further services or accessories in addition to the floor repair or replacement service, such as fitting, sub-floor preparation, underlay, metal bars, gripper, tape, glue, stair rod or any other services or accessories.

26-27. (canceled)

28. The method of claim 1 in which the end-user is able, via the application, to communicate directly with a service provider.

29. The method of claim 1 in which the end-user is able, via the application, to make a money payment to a service provider.

30. The method of claim 1 in which the method includes the step of providing a voucher or mandate or any other fulfilment process corresponding to the requested service to the end-user's application or web browser or web app.

31. The method of claim 1 in which the floor is any type of flooring such as carpet, brick, rugs, tile, stone or laminate.

32. The method of claim 1 in which the floor is a carpet and the measuring algorithm automatically estimates the number of rolls of carpet needed based on the roll's width and the dimensions or shape of the flooring area that needs to be repaired or replaced.

33-36. (canceled)

37. The method of claim 3 in which the classifier automatically determines or predicts the carpet's thickness.

38-39. (canceled)

40. The method of claim 1 in which the cost estimate is used to calculate a home insurance product for the end-user.

41. A machine learning based system for providing a cost estimate for a floor repair or replacement service, the system comprising one or more processors configured to:
(i) receive an image of a portion of the floor to be repaired or replaced from an end-user's application or web browser or web app running on the end-user's device;
(ii) generate based on the received image a cost estimate for the floor repair or replacement service using a machine learning model; and
(iii) provide the cost estimate to the end-user's application or web browser or web app.

42. (canceled)

43. A server configured to provide a cost estimate for a floor repair or replacement service, the server arranged to:
(i) receive an image of a portion of the floor to be repaired or replaced from an end-user's application or web browser or web app running on the end-user's device;
(ii) generate a cost estimate for the repair or replacement of the floor using a machine learning model; and
(iii) provide the cost estimate to the end-user's application or web browser or web app.

44. (canceled)

45. An application providing an end-user with an interface module configured to provide a cost estimate for a floor repair or replacement service, in which the end-user inputs an image of a portion of a floor to be repaired or replaced into the interface module and in which one or more processors, coupled to the interface module, are configured to generate, based on the received image, a cost estimate for the floor repair or replacement service using a machine learning model.

46-63. (canceled)
